(19) United States
(12) Patent Application Publication
(10) Pub. No.: US 2025/0284026 A1
(43) Pub. Date: Sep. 11, 2025

(54) ADVANCED IN-SITU SUBSURFACING AND SPECTROSCOPIC SYSTEM

(71) Applicant: Impossible Sensing LLC, St. Louis, MO (US)

(72) Inventors: Pablo Sobron, St. Louis, MO (US); Fredrik Rehnmark, Ithaca, NY (US)

(21) Appl. No.: 19/072,621

(22) Filed: Mar. 6, 2025

Related U.S. Application Data
(60) Provisional application No. 63/562,612, filed on Mar. 7, 2024.

(51) Int. Cl. G01V 8/02; G01N 21/71

(52) U.S. Cl. CPC G01V 8/02; G01N 21/71; G01N 2201/08

(57) ABSTRACT

A system and method for configuring and applying an integrated subsurfacing and spectroscopic analysis system for in-situ subsurface analysis are disclosed. In some embodiments, the method comprises configuring the integrated system to include a dual-path optical collection subsystem and an off-the-shelf laser. The method also includes applying the integrated system in subsurfacing environments for collecting sample measurements during drilling operations. The method further includes performing spectral analysis on the collected measurements for automated and real-time chemical and compositional identification during the drilling operations.

### CROSS REFERENCE TO RELATED APPLICATION

This application claims the benefit of and priority to U.S. Provisional Patent Application No. 63/562,612, filed Mar. 7, 2024, the entire content of which is incorporated by reference herein.

### TECHNICAL FIELD

This disclosure relates to subsurface analysis, in particular, to an integrated subsurfacing and spectroscopic analysis tool designed for in-situ subsurface analysis in geosciences, resource exploration, environmental monitoring, agriculture, construction, and planetary and asteroid exploration.

### BACKGROUND

There is increasing interest in applying subsurface-analytical techniques to characterize materials and provide important information on the composition of the materials in several fields such as geosciences, resource exploration, environmental monitoring, agriculture, construction, etc. However, current geochemical, biochemical, and mineralogical subsurface investigations in resource exploration, soil analysis, etc., are merely limited to scooping and analysis of drill tailings, cuttings, and core materials, which cause significant restrictions to different stages of drilling, sampling, processing, delivery, and analysis of subsurface investigations. For example, the scientific output from subsurface powders acquired using current approaches generally provides little or even no information about textural properties and spatial chemical/mineralogical contexts. There is a high risk of cross-sample contamination and sample transformation, and the approach itself is a resource-taxing activity involving multiple complex parts and mechanisms. Moreover, current subsurface analysis is costly and time-consuming, but it can only provide sparse, delayed data.

Hence, developing new instruments for in-situ characterization of subsurface environments is scientifically and technologically desirable.

### SUMMARY

To address the shortcomings mentioned above, a system and method for configuring and applying an integrated subsurfacing and spectroscopic analysis system for in-situ subsurface analysis are disclosed. In some embodiments, the method comprises configuring the integrated system (e.g., a LIBS-while-drilling system) to include a dual-path optical collection subsystem and an off-the-shelf laser. The method also includes applying the integrated system in subsurfacing environments for collecting sample measurements during drilling operations. The method further includes performing spectral analysis on the collected measurements for automated and real-time chemical and compositional identification during the drilling operations.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles, and features explained herein may be employed in various and numerous embodiments.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1A illustrates a graphic representation of a basic dual-path optical design.

FIG. 1B illustrates graphic representations of an example downhole probe assembly from two different perspectives, according to some embodiments.

FIG. 2 illustrates a graphic representation of the internal component configuration of an example downhole probe assembly, according to some embodiments.

FIG. 3A illustrates a graphic representation of a portable system where a probe assembly is integrated within a drill bit, according to some embodiments.

FIG. 3B illustrates an integrated Csystem with a rotating topside assembly, according to some embodiments.

FIG. 4A illustrates a graphic representation of spectra from a 50% water ice sample, according to some embodiments.

FIG. 4B illustrates a graphic representation of LIBS spectra obtained from a 1% water ice sample, according to some embodiments.

FIGS. 5A and 5B illustrate example test setup of the LIBS-while-drilling system, according to some embodiments.

FIG. 6 illustrates an exemplary flowchart for applying an integrated drilling system in subsurfacing environments for spectral analysis, according to some embodiments.

FIG. 7 illustrates a block diagram of an example computer system that may be used in implementing the technology described herein, according to some embodiments.

### DETAILED DESCRIPTION

The Figures (FIGs.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Overview

The present disclosure proposes a revolutionary integrated subsurfacing and spectroscopic analysis tool, designed for in-situ subsurface analysis in geosciences, resource exploration, environmental monitoring, agriculture, and construction. While the present disclosure hereafter mainly describes an exemplary drilling and spectroscopic tool for simplicity and clarity, it should be noted that the system and approach described herein are also applicable for other subsurfacing environments such as peneetrometers, wireline, etc.

In some embodiments, this spectroscopic analysis tool includes an ultra-compact laser spectroscopy system equipped with a fiber optic sensing probe that is embedded in a drill bit. A drill bit is a cutting or boring tool designed to penetrate and remove material from a surface or subsurface, which is typically attached to a rotating drill and used in various applications. The spectroscopy system includes a novel miniature optical probe to perform in-situ laser spectroscopy to enable unprecedented measurements. As compared to the existing approaches, the spectroscopy system fetches the measurements while drilling, and these measurements are rapid, direct, depth-resolved downhole geochemical, isotopical, biochemical, and mineralogical measurements. The proposed subsurfacing and spectroscopic analysis tool can also be mounted on a ground, airborne, seaborne, or spaceborne vehicle, thereby enabling in-situ 3D direct mapping on the surface and subsurface in different settings.

Some key advancements of the proposed subsurfacing and spectroscopic analysis system/tool include developing a laser system for generating laser-induced breakdown spectroscopy (LIBS) plasma from solid samples, integrating a general laser (e.g., commercial laser) for enhancing robustness, and designing a rotating drill with an integrated spectrometer to prevent optical signal loss. Additionally, the present system features a dual-path optical configuration, which enables efficient LIBS signal collection during operations.

The proposed spectroscopy subsurfacing system is a substantial technological leap to existing subsurface compositional analysis. First of all, the present approach combines drilling and laser spectroscopy into an integrated tool, such that measurements can be obtained during the operation of drilling. This drilling and spectroscopic analysis tool also benefits in some key aspects. Advantageously, the proposed spectroscopy subsurfacing system enables direct, rapid, subsurface, high-resolution spectral measurements without sample cross-contamination and with exact depth correlation of data. The present system minimizes the resources and complexity required to perform subsurface analyses, for example, eliminating the need for powder or core processing and delivery systems to the surface and/or labs. Because both drilling and subsurface analyses are realized within a single, integrated instrument, it can support many novel architectures.

An example of the proposed spectroscopy subsurface system integrates spectroscopy breadboards and laser subsystems within a drill bit to enable efficient and depth-resolved quantification of water content while drilling on the lunar surface. The present system allows real-time chemical and mineral profiling during lunar drilling, enhancing in-situ resource utilization (ISRU) capabilities. In some embodiments, the present system validates the capability for real-time and depth-resolved water content analysis at concentrations as low as 1%, which demonstrates the significant potential of the present system for future lunar exploration missions.

### Subsurfacing and Spectroscopic System

The present disclosure relates to a portable subsurfacing and spectroscopic system. In some embodiments, this spectroscopic system may include a laser-induced breakdown spectroscopy (LIBS), Raman, reflectance, or fluorescence instrument. The spectroscopic system may be specifically designed for downhole, in-situ analysis in various field conditions (e.g., resource exploration, environmental monitoring, agriculture).

In some embodiments, the proposed subsurfacing and spectroscopic system may include a compact, integrated downhole probe assembly, facilitating rapid and efficient collection of underground spectroscopic data. The downhole assembly may be configured for direct insertion into the ground. It includes a laser coupled with optics to focus the laser beam onto a targeted sample area. The laser generates optical signals under the control of a laser driver board. In some embodiments, the laser is configured to generate spectroscopic signals from a targeted sample area upon which the laser beam is focused. The laser driver board is configured to manage power and control signals to the laser for precise timing and energy delivery for sample analysis.

The proposed subsurfacing and spectroscopic system may also include a collection fiber that is optically positioned and connected to the downhole probe assembly and a spectrometer. The collection fiber may be configured to optically align with the plasma to collect the emitted light from the target and transmit it topside for analysis. In some embodiments, the proposed system may further include a microcontroller that is configured to manage data acquisition and processing from a spectrometer and communicate with a computing device to present the processed data.

In some embodiments, the proposed system is an integrated drilling and spectroscopic analysis tool. In some embodiments, the system is configured to operate with a ground penetrator to enable the insertion of the downhole probe assembly into geological formations.

### Downhole Probe Assembly

A downhole probe is an instrumented tool designed for subsurface analysis within a borehole or drill site. The probe described herein can detect and quantify elements and compounds within a drilled substrate (e.g., lunar regolith, rock formations, groundwater), and thus be used for in-situ chemical and mineral analysis. This probe enables geological stratification by measuring variations in composition at different depths, and can provide real-time data transmission for resource assessment and drilling optimization. The present probe is commonly used in geological exploration, environmental monitoring, resource extraction, and planetary drilling missions (e.g., lunar exploration).

In some embodiments, the downhole probe assembly described herein may employ a dual-path configuration, which allows the collection of optical signals (e.g., LIBS signals) in a second optical path parallel to the illumination path of the optical signals. This configuration significantly reduces the risk and lead times for component procurement.

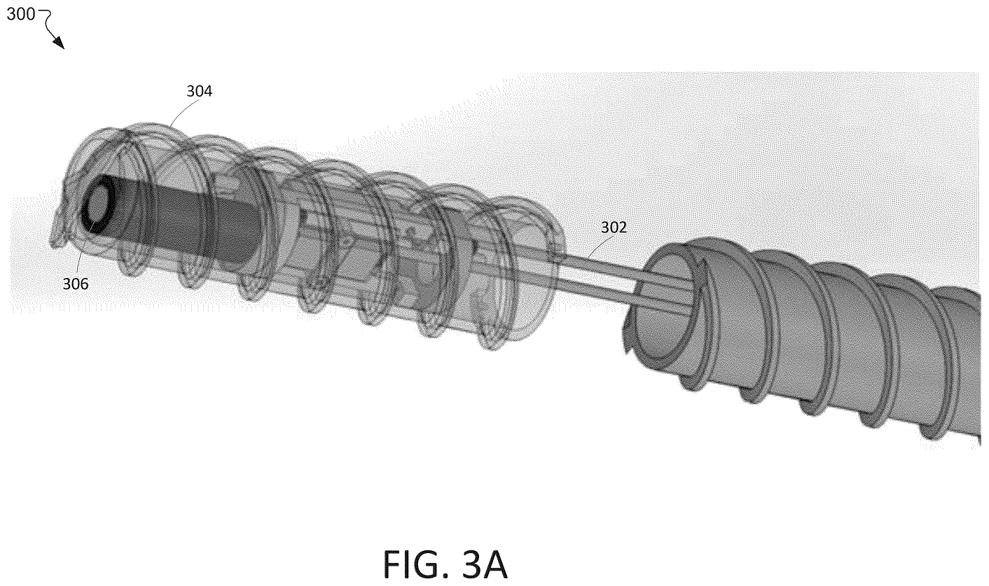

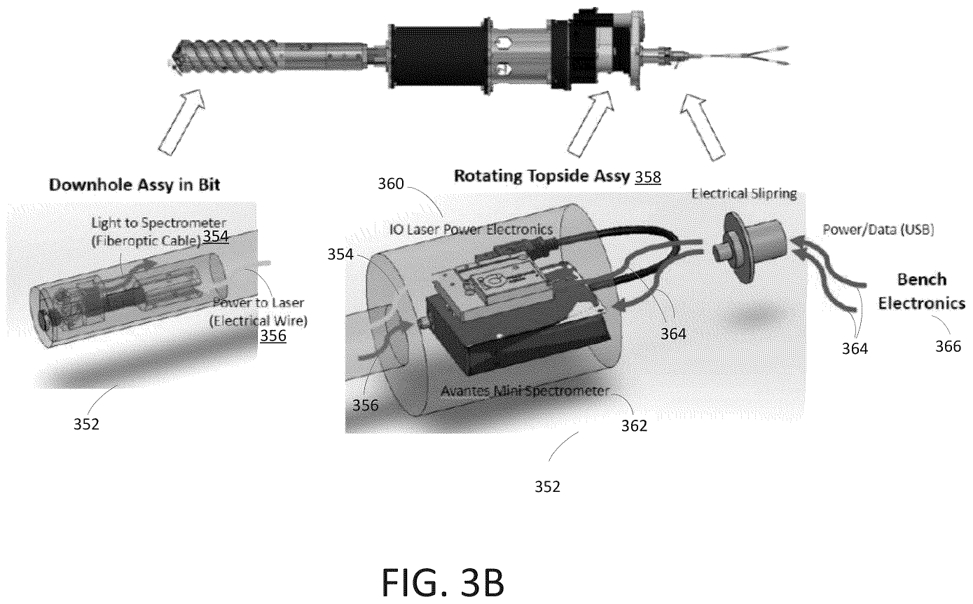

The dual-path optical configuration described herein addresses several technical challenges associated with real-time subsurface analysis. Optical signals (e.g., LIBS plasma signals) can scatter or weaken due to irregular regolith surfaces, drill vibrations, and material ejections in the confined and dusty subsurface drilling environments. The dual-path optical configuration enhances signal collection efficiency, ensuring that more emitted light reaches the spectrometer, leading to stronger and more reliable LIBS spectral data. The optical signals can also become weaker due to absorption and scattering in the confined drill hole as the drill penetrates deeper. The dual-path configuration optimizes light collection by capturing the emitted signals from multiple angles, increasing overall signal intensity. Additionally, the dual-path configuration, along with the rotationary drill (as described below in FIGS. 3A and 3B), can maintain optical alignment and ensure stable and consistent data acquisition, whereas traditional optical setups may face misalignment and optical distortion issues caused by drill rotation and movement in unpredictable areas (e.g., lunar terrain).

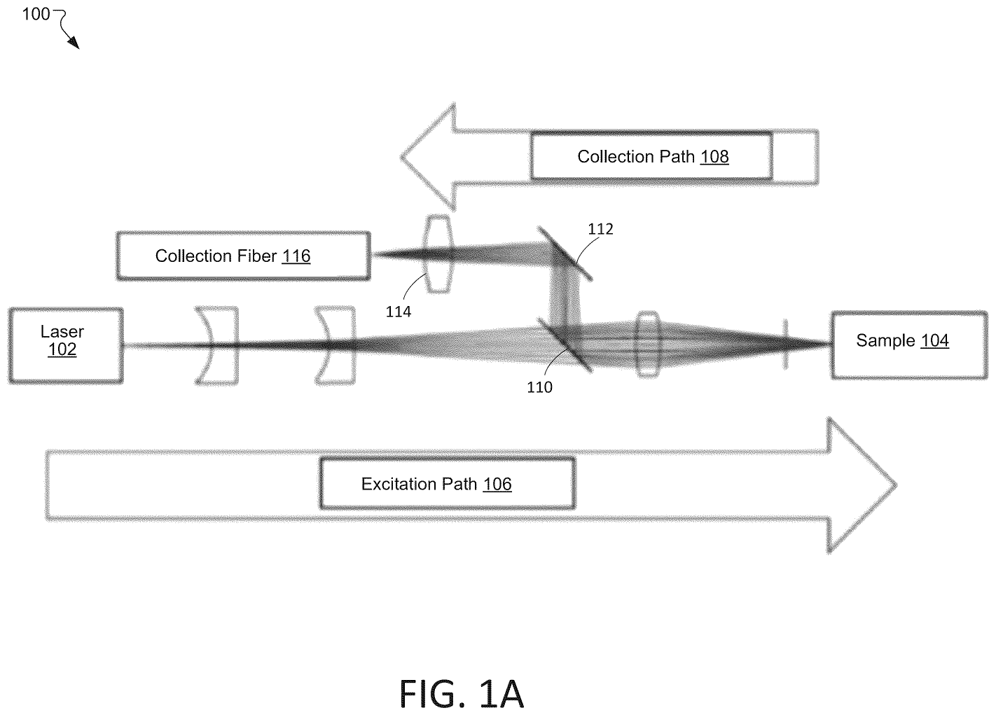

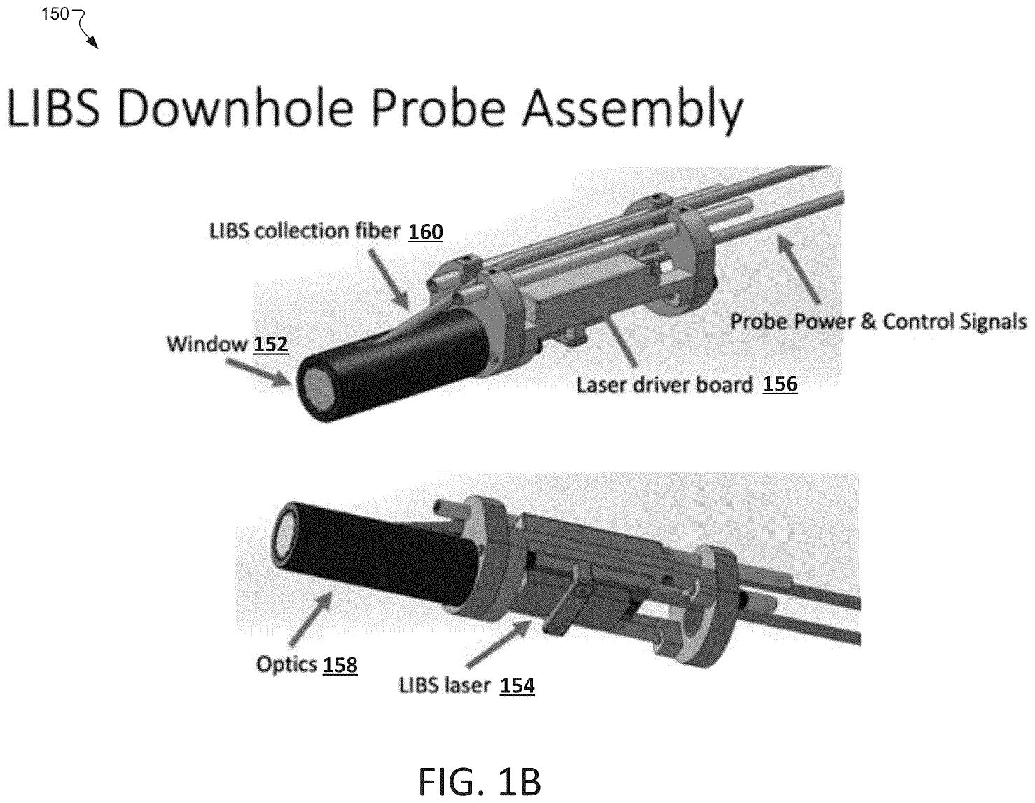

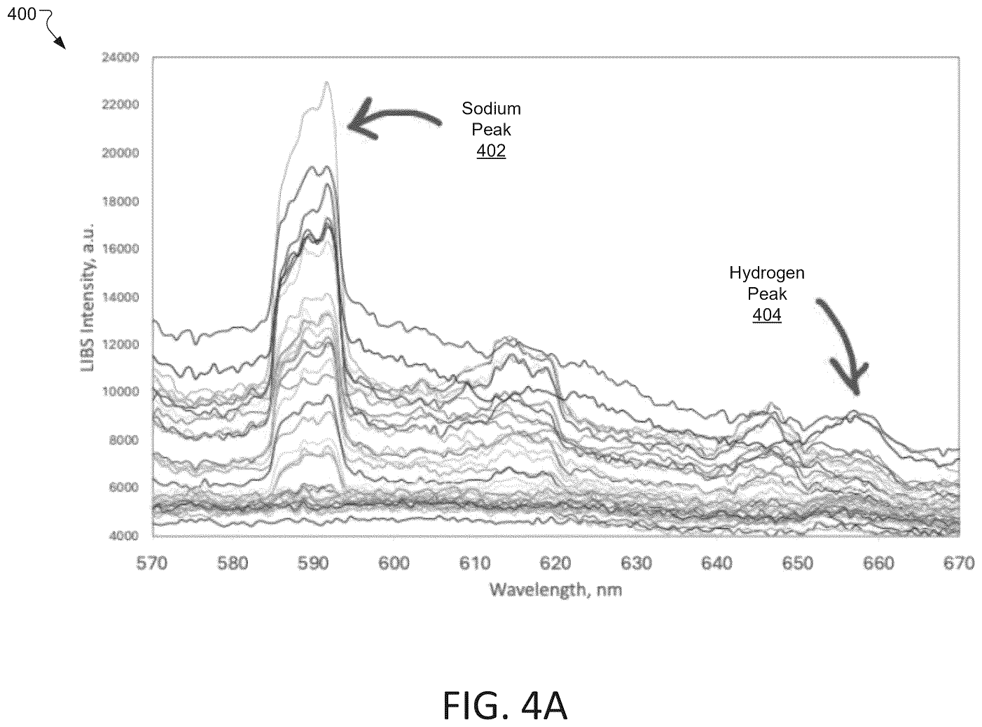

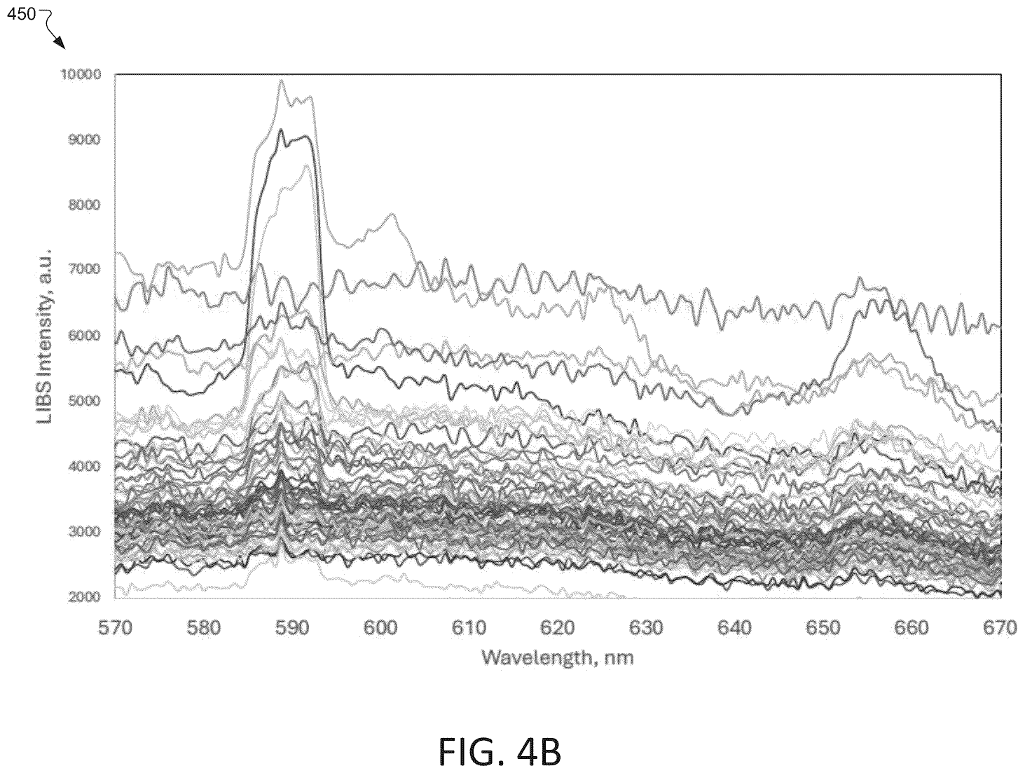

FIG. 1A illustrates a graphic representation 100 of a basic dual-path optical design. This dual-path configuration helps the subsurfacing and spectroscopic system achieve more robust and reliable analysis results (e.g., as shown in FIGS. 4A and 4B) than conventional single-path optical setups, even if this dual-path configuration initially introduces some complexity in geometry and constructional components. As depicted, a laser 102 emits an optical signal (e.g., plasma light) to illuminate a sample 104 through an excitation path 106. A second path, collection path 108, is added using the dual-path optical setting. Two mirrors 110, 112, and one lens 114 are included in collection path 108 to direct the optical signal into a collection fiber 116. In this initial dual-path setting, three potential misalignment points 110, 112, and 114 are added, increasing complexity and risk. Each mirror and lens needs precise alignment to ensure that the optical signal can be correctly captured and directed into collection fiber 108. Misalignments may lead to significant signal loss or degradation, impacting the overall system performance.

### Proposed Probe Assembly with Dual-Path Design and COTS Laser Integration

### Dual-Path Configuration

The present system is able to build a simplified, reliable downhole probe using a dual-path configuration, where a LIBS collection fiber is specifically angled relative to a laser, eliminating the need for additional optics (e.g., mirrors or lens) and ensuring efficient plasma light capture. FIG. 1B illustrates exemplary graphic representations of an advanced downhole probe assembly 150 from different perspectives, according to some embodiments. As compared to FIG. 1A, additional optics (e.g., 110, 112, and 114) are removed from LIBS downhole probe assembly 150 depicted in FIG. 1B. In some embodiments, the present system strategically positions a bare collection fiber at an angle relative to a light source (e.g., a laser), ensuring that the collection fiber captures optical signals without requiring extra components. This innovative placement allows the emitted light/signals to be directly funneled into the collection fiber without the three optics (e.g., 110, 112, and 114), thereby tremendously simplifying the dual-path design in FIG. 1A. This modification not only reduces potential misalignment issues but also streamlines the probe's optical path, making the subsurfacing and spectroscopic system more robust and easier to maintain.

The dual-path configuration efficiently handles optical signals, mitigating low transmissivity in a visible spectrum. This configuration also allows for the use of a conventional laser architecture (e.g., LIBS laser 154 in FIG. 1B), reducing risk and ensuring the integration of off-the-shelf components while meeting drill-bit accommodation requirements. Using the dual-path setup, the present system can obtain LIBS spectra of reference standards, which is important for calibrating the subsurfacing and spectroscopic system and ensuring accurate results (e.g., reliable water content measurements in the lunar regolith). The dual-path design facilitates efficient LIBS signal collection, enhancing the system's performance and reliability.

### Structure of Proposed Probe Assembly

LIBS downhole probe assembly 150 in FIG. 1B is an integral part of the portable system for field analysis. LIBS is a rapid chemical analysis technology that uses a short laser pulse to create a micro-plasma on the sample surface. LIBS offers many compelling advantages such as extremely fast measurement time, broad elemental coverage, versatile sampling protocols that include fast raster of the sample surface and depth profiling, etc.

As depicted in FIG. 1B, downhole probe assembly 150 may be an elongated cylindrical apparatus configured to be inserted into various geological formations. In the illustrated embodiment, a window 152 is provided at one end of the cylindrical body of probe assembly 150. Window 152 allows a laser beam to exit probe assembly 150 and interact with the surrounding material. In some embodiments, window 152 may be made of a durable, transparent material capable of withstanding the harsh environmental conditions encountered during field analysis.

Internally, probe assembly 150 may house a miniaturized laser 154, which serves as a primary source for generating the plasma. In some embodiments, laser 154 may be controlled by an onboard laser driver board 156. Board 156 is configured to deliver the power and control signals needed for the operation of laser 154. The positioning of laser 154 and optics 158 within probe assembly 150 is precisely aligned to ensure that the laser beam is directed through window 152 to a targeted area with high accuracy.

In some embodiments, optics 158 situated within probe assembly 150 includes lenses and other optical components. These optics 158 focus the laser beam to a fine point to achieve the desired interaction with the sample material. The configuration of these optic 158 is critical to the performance of the subsurfacing tasks (e.g., drilling, wirelining) and spectroscopic system because it determines the quality and intensity of the spectroscopic signals generated.

Adjacent to laser 154 and optics 158 is a collection fiber 160. In some embodiments, this collection fiber 160 may be strategically deployed to capture the light reflected from a target through the same window 152, and the captured light is then transmitted to a spectrometer for analysis. In some embodiments, dual-path optical design is applied, where collection fiber 160 captures the reflected light using a second optical path parallel to the illumination path. The efficiency of collection fiber 160 is vital for ensuring that a maximum amount of spectral data is relayed for analysis.

In some embodiments, the external body of probe assembly 150 further includes connections for probe power and control signals, which may be linked to the topside of assembly 150. These connections may be robustly configured to ensure consistent power supply and signal transmission, even in adverse field conditions.

### COTS Laser Integration

A commercial off-the-shelf (COTS) laser refers to a readily available, pre-manufactured laser system that can be integrated into various applications without requiring extensive customization. In some embodiments, a commercial microchip laser may be incorporated into the present system. For example, laser 154 in FIG. 1B may be a “μFlash” model from integrated optics. This laser, known for its compact size and high repetition rate, can provide a reliable and sufficient energy output for LIBS applications while simplifying the overall system design. For example, the μFlash laser demonstrates exceptional performance in generating LIBS spectra for water-bearing minerals. The high repetition rate and total energy delivery (e.g., 40.5 mJ per second) of this laser significantly outperform certain custom lasers, enabling the reliable detection of key spectral lines such as the hydrogen alpha line at 656 nm.

By leveraging commercially available technology, the risks associated with custom laser development is mitigated, ensuring a robust, flight-ready solution. The compact size of a COTS laser (e.g., μFlash laser) facilitates its integration into a drill bit, eliminating the need for a downhole optical fiber and reducing photon loss. The integration of a COTS laser along with the dual-path optical configuration not only enables a compact design compatible with various fields (e.g., a lunar drill bit), but also simplifies the system and improves LIBS signal acquisition, ensuring that the present system meets the intended goal of subsurface analysis.

### Internal Components of Downhole Probe Assembly

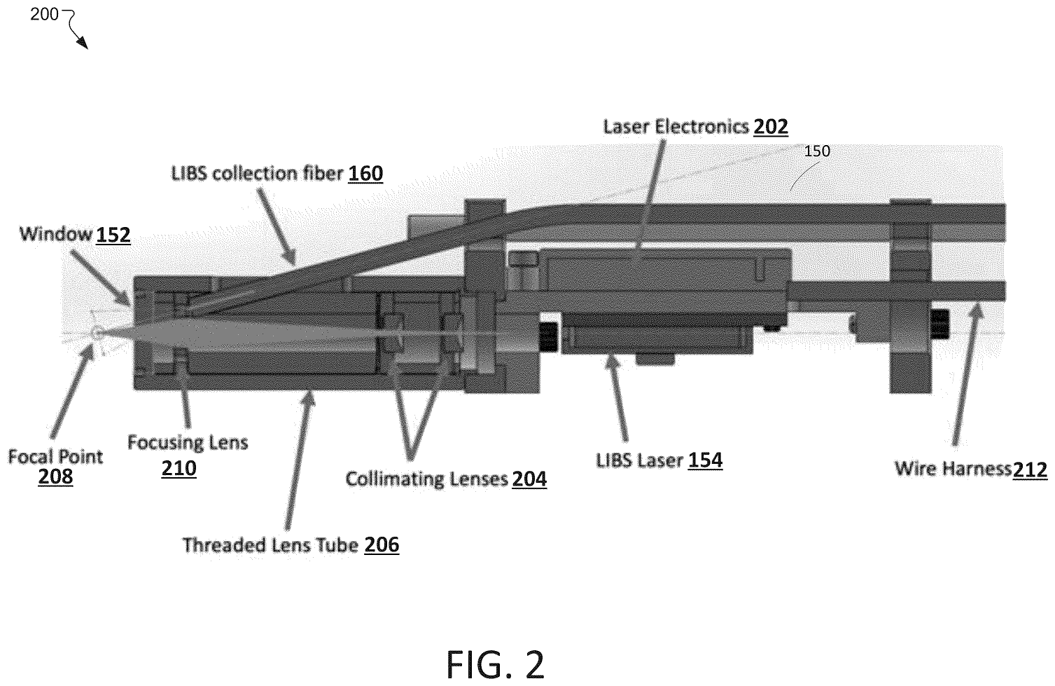

FIG. 2 illustrates a graphic representation of internal component configuration 200 of an example downhole probe assembly, according to some embodiments. In this example, a downhole probe assembly may be LIBS probe assembly 150 as shown in FIG. 1B.

Within the housing of assembly 150, the core components are meticulously aligned along the central axis. The laser (e.g., LIBS laser 154) is centrally positioned within probe 150, with its beam path directed towards window 152 at the distal end of probe 150. In some embodiments, laser electronics 202 are housed adjacent to laser 154. Laser electronics 202, including laser driver board 156 in FIG. 1B, is responsible for the operational control of laser 104, ensuring precise emission of laser pulses from laser 154.

In some embodiments, probe assembly 150 includes a threaded lens tube 206 that serves to shape and direct the laser beam from laser 154. A series of collimating lenses 204 may be positioned within threaded lens tube 206 for precise alignment of the laser beam. These lenses 204 are important to maintain the coherence of beams and ensure that the beams remain tightly focused over the distance to a focal point 208.

Focusing lens 210 is the final optical component through which the laser beam passes before exiting the probe 150. In some embodiments, focusing lens 210 is precisely positioned at a calculated distance from window 102 to focus the laser beam to a designated focal point 208 outside probe assembly 150. This focal point 208 is where the laser interacts with a sample material.

A collection fiber (e.g., LIBS collection fiber 160) is strategically deployed within the housing of probe assembly 150. Collection fiber 160 is used to collect the light emitted from a target at focal point 208. Collection fiber 160 can capture a wide spectrum of light which traverses back through window 102 and is then channeled through fiber 160 to a spectrometer for analysis.

As depicted in FIG. 2, wire harness 212 may be incorporated into the design of probe 150, to provide necessary electrical connections for power and control signals to the laser electronics 202 and ensure seamless integration with functions of probe assembly 150.

### Integration of Probe Assembly

The present disclosure proposes an integrated subsurfacing and spectroscopic analysis tool, which conveniently and efficiently acquires environmental measurements during the process of subsurface mining. FIG. 3A illustrates a graphic representation of a portable system 300 where a probe assembly is integrated within a drill bit, according to some embodiments.

In FIG. 3A, probe 302 is centrally mounted within a drill bit 304. Probe 302 can be a LIBS downhole probe assembly 150, as shown in FIGS. 1B and 2, and the integrated tool 300 can be applied in practical applications of field analysis. In some embodiments, drill bit 304 is specially designed to accommodate probe 302 and allow for its function while drilling, and integrated tool 300 is referred to as a LIBS-while-drilling system. As illustrated, the drill bit and probe assembly showcase a harmonious integration, where probe 302 is securely positioned to ensure stability and accuracy during operation.

In some embodiments, the transparent window 306 of probe 302 aligns with an aperture on drill bit 304. This allows the laser beam to exit and interact with the surrounding geological material. Window 306 allows passage of the laser beam and collection of the plasma light with minimal loss. This configuration may facilitate real-time analysis while drilling, providing immediate data on the composition of the drilled materials.

The collection fiber extends through the length of drill bit 304 and is protected within a robust casing. The casing shields the collection fiber from the mechanical stresses of drilling operations and protects the integrity of data transmission. This design ensures the safe transmission of spectral data from probe 302 to the surface equipment.

### Example System Configuration

The present disclosure introduces a revolutionary integrated subsurfacing and spectroscopic analysis tool, designed for in-situ subsurface analysis in geosciences, resource exploration, environmental monitoring, agriculture, construction, etc. For example, the system embodies an ultra-compact laser spectroscopy system, such as LIBS, Raman, reflectance, or fluorescence spectroscopy, equipped with a fiber optic sensing probe embedded within a drill bit. This integration facilitates direct, high-resolution spectral measurements during drilling operations, correlating data with precise depth without the risk of sample cross-contamination or the need for separate sample processing and delivery systems. The system boosts a specialized design featuring a sapphire window at the regolith/probe interface, which mitigates the need for a focusing mechanism due to the fixed window-to-sample distance and provides durability against environmental stresses. The novel architecture of the proposed system enables seamless 3D mapping of subsurface compositions, advancing the capability for rapid, direct, depth-resolved geochemical, biochemical, and mineralogical measurements in field conditions.

### Configuration for Probe Interface

In some embodiments, the proposed portable system 300 includes a special configuration for regolith or probe interface. This configuration is used to address the interface between the regolith and the probe 302, and is specifically tailored for optimal performance in harsh drilling environments.

In some embodiments, the special configuration for a portable system in drilling environments includes: configuring a sapphire window at a probe interface, where a distance between the window and a sample is fixed to negate the need for a focusing mechanism; using an optimized window placement at the tip of a drill bit for minimal cross-contamination; using a hollow drill stem for downhole fiber cable routing; applying a fiber optic rotary joint at a drill head for optical connection between downhole and topside fibers; and using a probe retention plate for secure installation within the drill bit.

### Sapphire Window Integration

In some embodiments, a sapphire window (e.g., 306) is included at the forefront of probe 302 and situated at the regolith/probe interface. The durable nature of sapphire makes it an ideal material for the window, due to its optical transparency across the ultraviolet to near-infrared (UV-NIR) range and its resistance to harsh environmental factors. The environmental factors may include temperature fluctuations, high pressure, potential abrasion and corrosion from the regolith, etc.

In some embodiments, window 306 is configured to be positioned in direct contact with the loose cuttings produced by the drilling action, rather than the undisturbed regolith. As a result, the window can be consistently cleared by the flow of fresh cuttings, maintaining a clean optical path and preventing any obstruction of the field of view from accumulated material.

### Fixed Window-to-Sample Distance

In some embodiments, the proposed subsurfacing and spectroscopic tool 300 is configured to provide a fixed distance between window 306 and the regolith. Given this fixed distance, established by the pressure of the drill bit against the sample, the need for a focusing mechanism is obviated. This design simplifies the optical system and ensures consistent focal conditions for spectral analysis.

### Optimized Positioning for Contamination Minimization

In some embodiments, window 306 is strategically located at the tip of drill bit 304, as opposed to a side-looking arrangement. This placement may guarantee an accurate correlation with the depth of the drilled sample and minimize the possibility of cross-contamination. The cross-contamination could arise from mixing materials along the auger's ascent.

### Probe Installation and Retention

In some embodiments, probe 302 may be installed through the rear of the detachable drill bit 304 and is secured into place using a retention plate. This design allows for easy installation and removal of probe 302, ensuring quick maintenance and replacement capabilities

### Drill Design and Fiber Cable Routing

In some embodiments, the drill features a hollow stem, allowing for the downhole fiber cable to be routed securely to the bit 304. The downhole optical fiber connected to probe 302 is configured to rotate with the drill stem, whereas the topside fiber that extends to the spectrometers is configured to translate up and down with the drill movement.

### Fiber Optic Rotary Joint (FORJ)

In some embodiments, the optical connection between the downhole and topside fibers may be facilitated by a fiber optic rotary joint (FORJ). FORJ may be mounted at the top of the drill head. FORJ couples light from the rotating drill bit (e.g., 304) to the fiber tether leading to the spectrometer, with signal losses being minimal and within a specified range. The FORJ component is applied to maintain the integrity of the optical signal despite the rotational motion of the drill.

### Rotating Topside

In some embodiments, the present system may combine a rotating drill design with an integrated spectrometer to eliminate the need for optical slip rings, positioning the system for seamless integration while ensuring efficient signal collection. Because optical slip rings are bypassed by using a rotating topside in a drill design, in some embodiments, this may cut the topside LIBS signal strength by half. For example, the present system allows an Avantes spectrometer (95×68×20 mm) and a laser electronics board to be directly integrated with the rotating drill bit, making them a single, cohesive unit. To achieved this, a short optical fiber cable and a flex cable may be used to connect the LIBS probe (e.g., 302) in the drill bit (e.g., 304), eliminating the need for an optical slip ring between the downhole operational components and the topside control and analysis hardware.

FIG. 3B illustrates an integrated drilling system with a rotating topside assembly. The downhole probe assembly is placed in a bit house as shown in 352, where arrow 354 indicates the fiber optic cable transmitting light to the spectrometer, and arrow 356 indicates the electrical wire powering the laser. A rotating topside assembly 358 is located on top of the drill, which contains laser power electronics 360 and a spectrometer 362 (e.g., an Avantes spectrometer). Topside assembly 358 is designed to rotate with the drill bit, eliminating the need for optical slip rings and reducing signal loss. Arrows 364 represent electric harness. Some essential electrical slip rings remain, providing power and data transfer to bench electronics 366 such as a power supply, data processing unit, etc.

### Configuration Refinement

The above configuration may be further refined to adapt to harsh drilling environments and/or meet specific analysis requirements. In some embodiments, window-sample geometry is adjusted to ensure consistent LIBS spectra in challenging drilling conditions. Window-sample geometry refers to the spatial arrangement and optical alignment of a window and a sample in an analytical or sensing system, particularly in spectroscopic applications such as LIBS. Some potential risks associated with the window-sample geometry are identified. These risks include possible damage to the optical components from regolith abrasion and challenges in maintaining alignment under operational conditions. Tests have been developed to mitigate these risks, involving simulations and physical tests to evaluate the impact of various factors such as pressure, temperature, and mechanical stress. These tests may guide the adjustments to enhance the robustness of the present system.

In some embodiments, the present system performed tests to address risks of scoring, marring, or coating the sapphire window (e.g., 306 in FIG. 3A) due to lunar soil abrasion and proximity to a LIBS plasma. The tests results indicated no significant damage, affirming the durability of the sapphire windows under simulated lunar conditions. For example, the consistency of LIBS spectra was obtained on the surface of the dry regolith as the drill rotates, demonstrating sampling success without penetrating the material. It is anticipated that, when drilling deeper into the regolith, the laser will fail to consistently ablate the regolith due to its proximity to the window surface. The present system intentionally focused the laser from the window (e.g., e.g., 306 in FIG. 3A) at a specific distance (e.g., 15 mm) to prevent pitting, which accounts for potential regolith lodging between the window and the focal plane and occurred approximately 50% of the time. Despite this, the present system consistently produced high-quality LIBS spectra every other second, achieving spatial resolutions of 1 mm during slow drilling and 4 mm at higher speeds. These spatial resolutions exceed the requirements for geological prospecting by over tenfold, validating the window-sample geometry refinement and ensuring the integrity of the optical components in the harsh lunar environment.

### LIBS-while-Drilling System Features

The present system utilizes LIBS-while-drilling technology, integrating an ultra-compact, fiber optic-sensed drill bit for conducting detailed downhole analysis during drilling. This advancement, coupled with the dual-function fiber LIBS probe, represents a major breakthrough in the field of in-situ resource utilization (ISRU) and scientific discovery. The expanded LIBS-in-bit architecture described herein allows in-situ measurements without the need for sample extraction. Additionally, by integrating a new commercial microchip laser into the optical path, the present system mitigates risks associated with custom laser development and demonstrates a robust and reliable system for in-situ resource analysis. The present system also strategically combines a rotating drill design with an integrated spectrometer, which eliminates the need for optical slip rings and positions the system for seamless integration (e.g., lunar mission integration) while ensuring efficient in-situ signal collection. The present subsurface spectroscopy system can be applied in a wide range of fields, including space exploration, as well as terrestrial applications such as mining, agriculture, and environmental monitoring.

### Example Validation of LIBS-while-Drilling System

An example validation of the LIBS-in-bit technology described herein is the quantification of water content in lunar regolith simulants. The present system generates high-quality LIBS spectra of lunar regolith simulants using the integrated drill setup. Specifically, the present system allows for sub-second water content analysis with a 1% quantitation limit and the creation of 3D in-situ resource maps without the need for regolith sampling and processing. This technological advancement enables real-time chemical and mineral profiling during drilling, significantly enhancing the system's ability to analyze the lunar regolith. The successful detection of water ice at depth within the regolith, even at low concentrations of 1%, highlights the system's potential to identify and analyze critical resources, marking an important step of enhanced ISRU for lunar exploration missions.

A series of experiments were conducted to illustrate the present system's capacity to detect and quantify water ice in lunar regolith simulants at depths, confirming the effectiveness of the disclosed real-time analysis. In the experiments, samples were prepared using a lunar regolith simulant (e.g., JSC-1) mixed with water ice at varying concentrations (e.g., 0%, 1%, 10%, etc). The selected lunar regolith simulant closely mirrors lunar soil in both physical and chemical properties. The mixtures were kept frozen with CO₂ ice to replicate lunar surface conditions. A high-beam-quality laser was then used to generate clean, deep craters in a sample. The present system employed a dynamic sampling method by moving the sample to expose a fresh surface with each laser pulse, which simulates the drilling process where new material is exposed continuously as well as avoiding signal loss due to focal changes.

Since a silicate-to-hydrogen ratio varies with each laser shot due to changing volumes of silicate and ice being ionized, the present system measures the occurrences of hydrogen peaks to quantify water content in the samples. In the example experiments, for each sample, 100 laser shots are performed, and the frequency and intensity of the hydrogen peaks are recorded.

It was found that the frequency and intensity of hydrogen peaks (e.g., around 656 nm) in the LIBS spectra correlated with water ice concentration. Samples with higher ice content showed a greater frequency of hydrogen and more intense peaks, indicating that multiple ice grains were ionized. Drier samples exhibited fewer spectra with hydrogen peaks, which was consistent with the lower water concentration. Based on the 100+ laser shots recorded per sample, a clear qualitative trend was revealed. As ice content increased, so did the frequency and intensity of hydrogen peaks.

FIG. 4A illustrates a graphic representation 400 of spectra from the 50% water ice sample. The prominent sodium peak 402 at approximately 589 nm originates from the lunar regolith simulant (e.g., JSC-1), while the hydrogen peak 404 around 656 nm indicates water ice. The presence of both signatures (e.g., 402, 404) across multiple spectra validates the reliability of the disclosed LIBS-in-bit approach in quantifying water within regolith.

FIG. 4B illustrates a graphic representation 450 of LIBS spectra obtained from the 1% water ice sample. As depicted, hydrogen peaks are present occasionally and at a much lower frequency than that in FIG. 4A. This lower frequency of hydrogen peaks in the 1% sample highlights the sensitivity of the disclosed method in detecting varying water content levels. It confirms the effectiveness of this approach in quantifying low concentrations of water in lunar regolith simulants.

The experiment results in FIGS. 4A and 4B conclusively demonstrate the capability of the disclosed LIBS-in-Bit technology to accurately quantify water content in lunar regolith simulants. The consistent detection results validate that the approach, moving the sample between analyses and measuring the frequency and intensity of hydrogen peaks, effectively simulates the dynamic environment of lunar drilling, providing robust data for in-situ resource analysis.

### Example LIBS-while-Drilling Test Setup

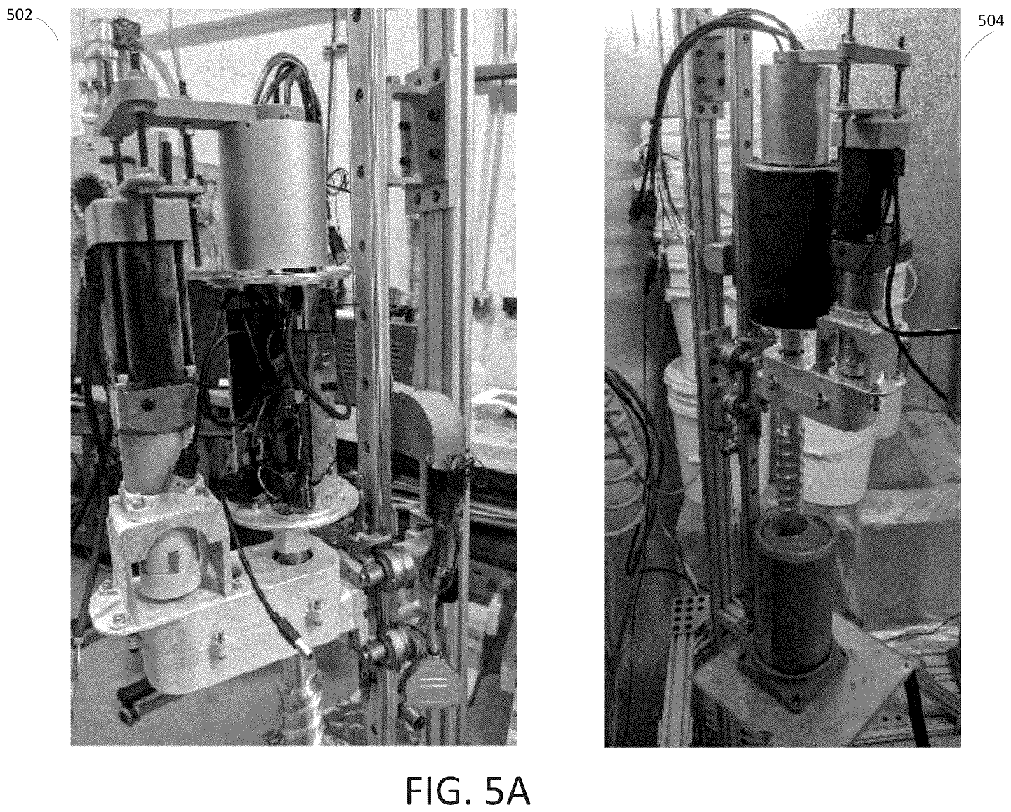

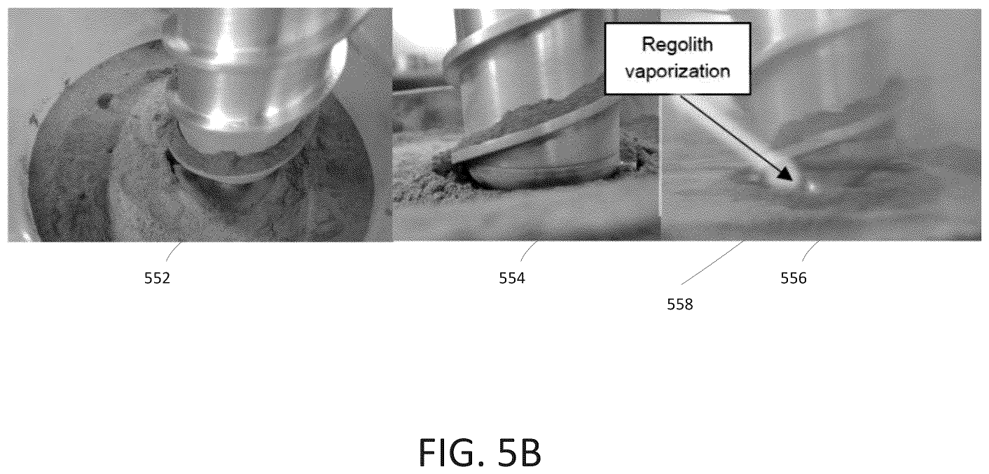

The disclosed drill and LIBS system can be integrated, for example, to conduct the above experiments for quantifying water content in lunar regolith simulants. FIGS. 5A and 5B illustrate example test setup of the LIBS-while-drilling system. As shown in FIG. 5A, the system is integrated and transferred to a low-temperature chamber (e.g., −10° C.) to simulate the cold conditions of the lunar regolith. Representation 502 shows the assembled drill and LIBS components during surface testing, highlighting an auger motor, optical control assembly, and geartrain. Representation 504 shows the disclosed system within a freezer environment for simulated lunar regolith drilling, demonstrating the robust setup designed to withstand extreme conditions.

When testing the integrated drill and LIBS system shown in FIG. 5A, dry regolith simulant (e.g., BP-1) was involved. The auger operated at a speed of 10 RPM with a penetration rate of 0.5 to 2 mm/s. The laser fired at one-second intervals, with the spectrometer measuring the emitted light through a fiber optic cable. FIG. 5B captures the process of regolith vaporization under the integrated drill and LIBS system. Graphic representation 552 and 554 show the auger in contact with the regolith. In contrast, representation 556 highlights the visible ablation process. During the test, the spectrometer successfully measured the regolith approximately 1.5 cm from the laser window, which was consistent with the system design. This optimal distance allowed for effective ablation of the regolith, indicated by a single glowing point of light 508, confirming effective LIBS operation.

### Additional Embodiments

The subsurfacing and spectroscopic system such as a LIBS-in-bit system is an advanced real-time, depth-resolved spectroscopic tool designed for geosciences, resource exploration, environmental monitoring, agriculture, and construction. It integrates a COTS microchip laser to help generate stable optical signals, ensuring precise chemical and mineral profiling. A dual-path optical configuration enhances signal collection efficiency, while a rotating drill with an integrated spectrometer eliminates the need for optical slip rings, simplifying system design and improving robustness. The present system also utilizes an ultra-compact, fiber-optic-sensed drill bit, allowing for sub-second water quantification with a 1% detection limit, even in deep regolith layers.

Although lunar exploration is discussed above as an example application, the unique features of the present system establish it as a breakthrough technology with broad applicability across multiple domains, significantly enhancing real-time ISRU (in-situ resource utilization) and scientific discovery. Beyond space exploration, the present subsurface spectroscopy system can be utilized in various terrestrial applications, including mining, agriculture, and environmental monitoring.

For example, in mining exploration, the system enables real-time analysis of reverse circulation (RC), air core (AC), or rotary air blast (RAB) drill cuttings, providing real-time chemical and mineralogical assessments that support the evaluation of percussion drilling materials. This capability improves efficiency in mineral prospecting, reducing the need for time-consuming laboratory analyses.

In agriculture, the present system can be deployed for on-site soil analysis, allowing for the rapid quantification of nutrient content, moisture levels, and contaminants. This real-time data aids in precision farming, optimizing fertilization, irrigation, and land management strategies to enhance crop yield and sustainability.

Additionally, in environmental monitoring, the present system can be used for groundwater and soil contamination assessments, detecting pollutants (e.g., heavy metals, hydrocarbons, hazardous chemicals, etc.) in real time. This rapid detection capability supports early intervention strategies to mitigate ecological damage and ensure environmental compliance.

With its versatile real-time subsurface analysis, the present system represents a transformative advancement in both planetary and terrestrial exploration, offering unparalleled efficiency, accuracy, and adaptability across diverse scientific and industrial applications.

The present system delivers a scalable, cost-effective, and field-ready solution for commercial mineral exploration. Its ability to perform real-time, depth-resolved chemical analysis makes it a useful tool for geologists, mining companies, and exploration teams, accelerating the discovery, characterization, and sustainable extraction of valuable mineral resources. For example, in real-time elemental and mineral profiling, the present system allows geologists and mining companies to identify valuable ore deposits (e.g., lithium, rare earth elements, gold, and copper) quickly, reducing the time needed for time-consuming assay lab testing. By providing instant LIBS spectra, mining operators can make real-time drilling decisions, optimizing borehole placement and minimizing unnecessary drilling. The present system's ability to quantify mineral concentrations in situ reduces reliance on costly and time-consuming sample transportation and laboratory analysis.

The use of a COTS laser ensures portability and ruggedness, making the present system suitable for harsh mining environments. The present system can be mounted on drilling platforms or handheld analyzers, allowing flexibility in exploration, core logging, and mineral prospecting. The dual-path optical configuration and fiber-optic sensing improve signal quality, enabling the detection of trace elements and mineral alterations with high sensitivity. This ensures more accurate resource estimation, aiding in the classification of ore grades and deposit viability. The present system facilitates early detection of harmful contaminants such as arsenic, mercury, or heavy metals, helping mining operations adhere to environmental regulations. It supports responsible resource extraction by reducing the need for destructive sampling methods.

The present system can also integrate with machine learning (ML) algorithms to perform an artificial intelligence (AI)-driven spectral analysis, significantly enhancing real-time chemical and mineral profiling across multiple domains, including natural resource exploration (mining, oil & gas), environmental monitoring, planetary exploration, etc. For example, by leveraging ML algorithms alongside a kernel partial least squares regression (K-PLSR) model, the present system can automate and refine LIBS spectral interpretation, leading to greater accuracy, efficiency, and adaptability in complex geological environments. These ML algorithms can further be applied in instantaneous mineral classification, quantification of chemical abundances, and pattern recognition in large spectral datasets, reducing human error and improving decision-making in resource exploration.

Additionally, the present system may incorporate AI-powered predictive modeling to perform real-time anomaly detection, helping identify valuable ore deposits, hydrocarbon reservoirs, or environmental contaminants before full-scale excavation. The integration of self-learning spectral models in the present system may ensure continuous refinement of classification algorithms, allowing the system to adapt dynamically to new geological conditions and planetary environments. By merging AI with real-time LIBS spectroscopy, the present system may achieve unparalleled efficiency in subsurface analysis, marking a transformative leap in both terrestrial and extraterrestrial resource characterization. Examples of using ML learning techniques to enhance LIBS analysis are described in U.S. Patent Application Publication No. 2019/0079019, titled “Non-linear methods for quantitative elemental analysis and mineral classification using laser-induced breakdown spectroscopy (LIBS),” and filed on Aug. 15, 2018, the entire contents of which are incorporated by reference herein.

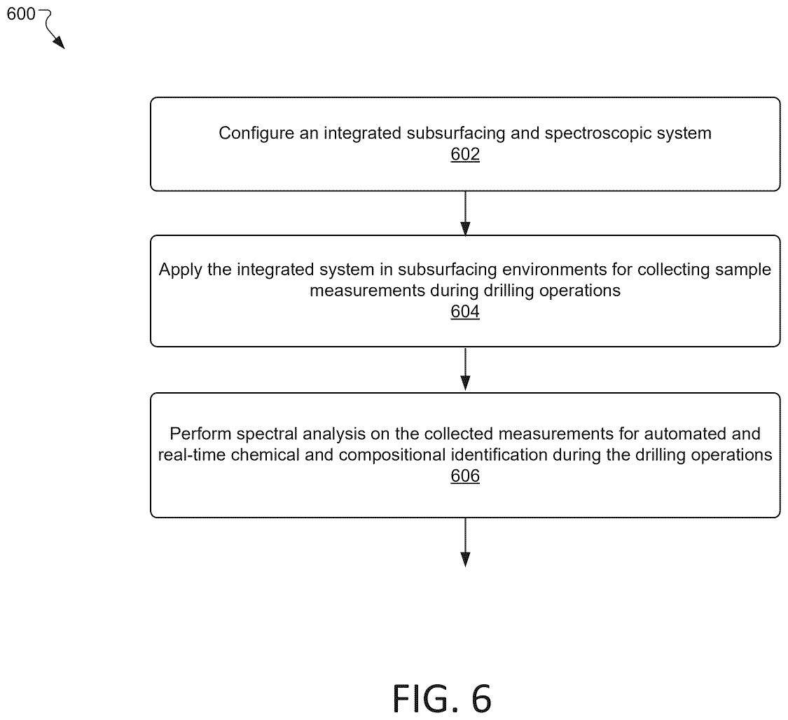

FIG. 6 illustrates an exemplary flowchart 600 for applying an integrated drilling system in subsurfacing environments for spectral analysis. In some embodiments, the integrated system is a LIBS-while-drilling system, as shown in FIG. 3A.

At step 602, the integrated system is configured to be applied to a harsh drilling environment. In some embodiments, the configuration includes configuring a dual-path optical collection subsystem and incorporating an off-the-shelf laser. Based on the dual-path configuration, a collection fiber can collect a laser beam using a separate optical path parallel to an illumination path in which the laser emits the laser beam. The dual-path configuration benefits the system in eliminating signal loss and enhancing efficiency. Additionally, the COTS laser such as a μFlash laser may be incorporated into the system to improve laser stability and longevity, which help beam quality and energy delivery to regolith samples.

At step 604, the integrated system is applied in the subsurfacing environments for collecting measurements obtained from a sample during drilling operations. For example, the integrated system may be used to measure frequency variations of LIBS signals and to perform quantitative analysis based on the measured frequency variations to determine subsurface water content.

At step 606, a spectral analysis is performed on the collected measurements for automated and real-time chemical and compositional identification during the drilling operations. For example, the water ice at concentrations as low as 1% can be detected in real time while drilling. In some embodiments, the analysis may be an AI-driven analysis for enhanced efficiency and accuracy.

### Computer Implementation

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used, and/or functional programming languages can be used. Electrical memory, such as flash-based memory, can be used.

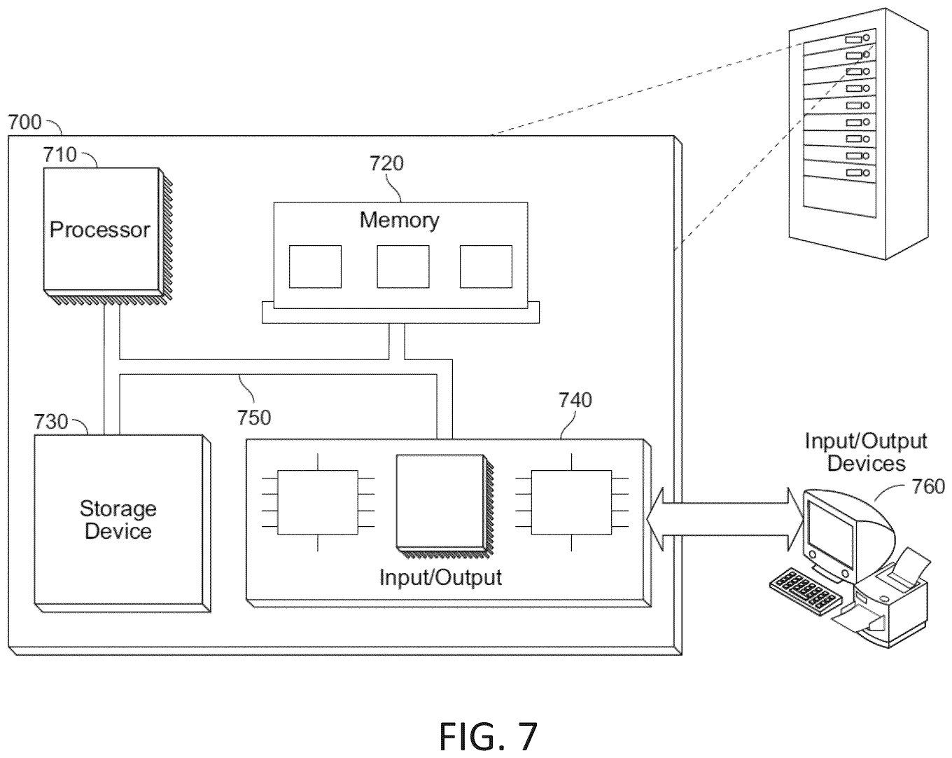

FIG. 7 is a block diagram of an example computer system 700 that may be used in implementing the technology described herein. General-purpose computers, network appliances, mobile devices, or other electronic systems may also include at least portions of the system 700. The system 700 includes a processor 710, a memory 720, a storage device 730, and an input/output device 740. Each of the components 710, 720, 730, and 740 may be interconnected, for example, using a system bus 750. The processor 710 is capable of processing instructions for execution within the system 700. In some implementations, the processor 710 is single-threaded. In some implementations, the processor 710 is a multi-threaded processor. The processor 710 is capable of processing instructions stored in the memory 720 or on the storage device 730.

Memory 720 stores information within the system 700. In some implementations, the memory 720 is a non-transitory computer-readable medium. In some implementations, the memory 720 is a volatile memory unit. In some implementations, the memory 720 is a non-volatile memory unit.

The storage device 730 is capable of providing mass storage for the system 700. In some implementations, the storage device 730 is a non-transitory computer-readable medium. In various implementations, the storage device 730 may include, for example, a hard disk device, an optical disk device, a solid-state drive, a flash drive, or some other large-capacity storage device. For example, the storage device may store long-term data (e.g., database data, file system data, etc.). The input/output device 740 provides input/output operations for the system 700. In some implementations, the input/output device 740 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer, and display devices 760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, executable code, or other instructions stored in a non-transitory computer-readable medium. The storage device 430 may be implemented in a distributed way over a network, such as a server farm or a set of widely distributed servers, or may be implemented in a single computing device.

Although an example processing system has been described in FIG. 7, embodiments of the subject matter, functional operations, and processes described in this specification can be implemented in other types of digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special-purpose logic circuitry, e.g., an FPGA (field programmable gate array) or an ASIC (application-specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program can include, by way of example, general or special purpose microprocessors or both, or any other kind of central processing unit. Generally, a central processing unit will receive instructions and data from a read-only memory, a random access memory, or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer-readable media suitable for storing computer program instructions and data include all forms of non-volatile memory, media, and memory devices, including way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special-purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship between client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A probe assembly of a portable subsurfacing and spectroscopic system, comprising:
a cylindrical body;
a laser positioned within the body and configured to emit a laser beam through a window at one end of the body; and
a collection fiber configured to collect the laser beam based on a dual-path optical setting and transmit the captured beam to a spectrometer for field analysis.

2. The probe assembly of claim 1, wherein, based on the dual-path optical setting, the collection fiber is configured to collect the laser beam using a separate optical path parallel to an illumination path in which the laser emits the laser beam.

3. The probe assembly of claim 1, wherein the window is adjusted geometrically to ensure consistent optical spectra in different drilling conditions.

4. The probe assembly of claim 1, wherein the laser is an off-the-shelf laser with no customization, and the off-the-shelf laser includes a u Flash laser.

5. The probe assembly of claim 1, further comprising a wire harness configured to provide electrical connections to laser electronics, wherein the connections for probe power and control signals interface with a topside assembly.

6. The probe assembly of claim 5, wherein the laser electronics are housed adjacent to the laser to control the emission of the laser beam.

7. The probe assembly of claim 1, wherein the window is made of a material capable of withstanding environmental conditions encountered during the field analysis.

8. The probe assembly of claim 7, wherein the window is used to allow passage of the laser beam and collection of the plasma light with minimal loss.

9. A portable subsurfacing and spectroscopic system comprising:
a probe integrated into a drill bit through a central mounting, wherein:
an aperture on the drill bit is aligned with a window of the probe for collecting an optical signal from a laser; and
a casing within the drill bit is used to protect a collection fiber, wherein the collection fiber is configured to capture and transmit the laser beam to a spectrometer for spectral analysis.

10. The portable subsurfacing and spectroscopic system of claim 9, wherein the laser, the spectrometer, laser, and power electronics are integrated into a rotating drill attached to the drill bit without optical slip rings.

11. The portable subsurfacing and spectroscopic system of claim 10, wherein a short optical fiber cable and a flex cable are used to connect the probe in the drill bit.

12. The portable subsurfacing and spectroscopic system of claim 9, wherein integration of the probe within the drill bit allows for real-time spectroscopic analysis during drilling operations.

13. The portable subsurfacing and spectroscopic system of claim 9, wherein the probe is securely positioned within the drill bit to maintain stability and accuracy of laser-induced plasma generation and light collection.

14. The portable subsurfacing and spectroscopic system of claim 9, wherein the casing for the collection fiber is constructed to withstand mechanical stresses during drilling and protect integrity of data transmission.

15. A method for applying an integrated laser induced breakdown spectroscopy (LIBS)-while-drilling system in subsurfacing environments for spectral analysis, the method comprising:
configuring the integrated system to include a dual-path optical collection subsystem and an off-the-shelf LIBS laser;
applying the integrated system in subsurfacing environments for collecting sample measurements during drilling operations; and
performing the spectral analysis on the collected measurements for automated and real-time chemical and compositional identification during the drilling operations.

16. The method of claim 15, wherein performing the spectral analysis comprises detecting water ice at a 1% concentration in real time while drilling.

17. The method of claim 15, wherein performing the spectral analysis comprises:
measuring frequency variations of LIBS signals; and
performing quantitative analysis based on the measured frequency variations to determine subsurface water content.

18. The method of claim 15, wherein the spectral analysis is an artificial intelligence (AI)-driven spectral analysis.

19. A method for configuring a portable system in subsurfacing environments, the method comprising:
configuring a window at a probe interface, wherein a distance between the window and a sample is fixed to negate the need for a focusing mechanism;
positioning the window at a specific angle and location at the tip of a drill bit to minimize cross-contamination;
using a hollow drill stem for downhole fiber cable routing;
applying a fiber optic rotary joint at a drill head for an optical connection between downhole and topside fibers; and
using a probe retention plate for secure installation within the drill bit.

20. The method of claim 19, wherein the window is a sapphire window, and the sapphire window is resistant to temperature, pressure, abrasion, and corrosion, and maintains optical transparency in an ultraviolet to near-infrared (UV-NIR) range.

21. The method of claim 20, wherein the sapphire window contacts with loose cuttings from drilling, and the contact provides a scouring effect such that an optical path remains unobstructed.

22. The method of claim 19, wherein the fiber optic rotary joint accommodates a rotational movement of the drill stem while maintaining integrity of the optical signal.

23. The method of claim 19, wherein the probe is configured to install through the rear of the detachable drill bit and be secured with the retention plate.
